(19) United States
(12) Patent Application Publication
(10) Pub. No.: US 2009/0227441 A1
(43) Pub. Date: Sep. 10, 2009

(54) Refractory shaped body with increased alkali resistance

(76) Inventors: Heinrich Liever, Dransfeld (DE); Hans-Jurgen Klischat, Gleichen (DE); Holger Wirsing, Gottingen (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 12/454,143

(22) Filed: May 12, 2009

Related U.S. Application Data
(63) Continuation of application No. 11/999,493, filed on Dec. 5, 2007, now abandoned.
Application No. 11/999,493 is a continuation of application No. 10/843,341, filed on May 12, 2004, now Pat. No. 7,101,338.
Application No. 10/843,341 is a continuation of application No. 10/083,989, filed on Feb. 26, 2002, now abandoned.

(30) Foreign Application Priority Data
Feb. 26, 2001 (DE) 101 09 267.9

(51) Int. Cl. C04B 35/565

(52) U.S. Cl. 501/89

(57) ABSTRACT

The invention relates to a refractory batch and to a process for its production. The batch comprises a refractory metal oxide main component containing Al₂O₃; the refractory metal oxide main component containing 40 to 60% by weight of Al₂O₃; a phosphate bond, in particular, the phosphate bond being produced by at least one of a phosphoric acid and a monoaluminum phosphate; finely particulate SiC having a grain size of <0.2 mm, the batch containing 3 to 15% by weight of the finely particulate SiC; and the grain size distribution of the SiC being selected so that more than 2.0% of the SiC, based on a total quantity of the batch, is <0.045 mm, whereby said batch excludes the presence of boron phosphate.

### RELATED APPLICATION

This application is a continuation of U.S. Ser. No. 11/999,493 filed Dec. 5, 2007 which in turn is a continuation of application Ser. No. 10/843,341, filed on Apr. 28, 2004, now abandoned which is a continuation of application Ser. No. 10/083,989, filed on Feb. 26, 2002, now abandoned, which claims priority from German Patent Application No. 101 09 267.9 filed on Feb. 26, 2001, the priority of which is hereby claimed. The contents of each of which are wholly incorporated herein by reference.

### BACKGROUND OF THE INVENTION

The invention relates to a refractory batch and to a process for its production. Refractory materials which are used for lining kiln and furnace vessels and chambers are often subject to high chemically corrosive loads from alkaline metal salts of a complex composition. This chemically corrosive load prevails in particular in a temperature range from 700 to 1300° C.

The origin of the salts is complex. Both the material being fired and the fuels often liberate alkali metals. These alkali metals are known to form low-viscosity salts in the corresponding temperature range and act as fluxes, i.e. agents which reduce the melting point, in most refractory or ceramic systems.

In the cement industry, for example, the alkali metals originate in part from the—in particular clay-containing—raw materials. Furthermore, the alkali load has risen considerably on account of the fuels which are in use nowadays. Particularly when firing the cement clinker in rotary tubular kilns, the fuel has been changed from relatively clean natural gas and oil to lower-quality coals and waste fuels, such as rubber tires, waste oils, plastics and solvents. These fuels have the advantage of being favorable given a sufficient energy content and, moreover, of being thermally disposed of, as remainder materials, at the temperatures which prevail in the rotary tubular kilns. However, the chemically corrosive wear caused by volatile substances, such as complex alkali metal salts, which escape or are formed during the combustion has risen drastically. These chemically corrosive, complex salts substantially comprise: K⁺, Na⁺, O²—, SO₃²⁻, Cl⁻, OH⁻F⁻, S²⁻. Depending on the molar ratio, the chemically corrosive salts which are formed substantially comprise the following individual components: K₂SO₄, Na₂SO₄, Na₂O, K₂O, NaOH, KOH, KCl, NaCl. The oxygen partial pressure and the molar ratio of alkali metal oxides to SO₃ have a further influence on the composition of these salts. For example, at a low oxygen partial pressure sulfides are formed, while at a high oxygen partial pressure the corresponding sulfates are formed. If the molar ratio of alkali metal oxide to SO₃ is below 1, alkali metal oxide is formed as well as alkali metal sulfate, while if the molar ratio is above 1, SO₂/SO₃ is formed as well as alkali metal sulfate.

The temperature range from 700 to 1300° C. is particularly critical, since the alkali metal salts, which are usually volatile at over 1300° C., are deposited on the refractory lining within this temperature range, and then infiltrate and corrode this lining. Under the action of the temperature gradient, this infiltration and corrosion takes place to a very great depth, in many cases even down to the metallic kiln shell. Therefore, particularly in the case of a rotary tubular kiln, the kiln section or the refractory lining of the kiln section in which the temperatures are between 700 and 1300° C. is subject to a particularly high load. The corrosion processes are, firstly, the infiltration, the infiltration by the alkali metal salts causing the microstructure to be compacted and become brittle and, moreover, the bonding is loosened by the crystallization pressure. This results in premature wear on account of hot abrasion and flaking. Furthermore, the increase in thermal conductivity, in conjunction with the wear mechanism described above, allows dangerous overheating of the metallic kiln shell.

Moreover, chemical corrosion takes place, in which the infiltrates react with the primary phases of the refractory lining, so as to form new, secondary phases which are lower than the actual application melting point. Furthermore, volumetric expansion can be observed. Overall, therefore, the wear caused by chemical corrosion takes place through melting, hot abrasion and also flaking.

It is known to use refractory shaped bodies with Al₂O₃ contents of 40 to 60% by weight in the safety and preheating zones of rotary kilns used in the cement industry. Both natural and synthetically produced raw materials, i.e. in particular natural raw materials from the sillimanite group, bauxite and refractory clay, can be used for the production of high-alumina bricks, as are used in particular in the abovementioned field of rotary tubular kilns in the cement industry. Suitable synthetic raw materials are sintered mullite, fused mullite, calcined alumina, sintered conrundum and fused conrundum. Numerous attempts have already been made to improve the alkali resistance of refractory products from the Al₂O₃—SiO₂ system, in particular in the cement sector.

DE 36 33 816 relates to a refractory composition for the production of refractory bricks which are said to have a high resistance to alkaline attack. The material described is to have a minimum alumina content of 60% by weight. It is stated in that document that one of the solutions for improving the alkali resistance is to reduce the alumina content from a minimum of 60% by weight to 50% by weight. 50% by weight of SiO₂ would then be added to this 50% by weight of Al₂O₃. However, this is highly detrimental to the refractory properties of the brick, so that overall, although the alkali resistance is improved, the refractory strength becomes unsatisfactory. To increase the alkali resistance, high-alumina bricks containing 60% by weight of alumina were mixed with zirconium, phosphorous acid, titanium dioxide and boric acid. Moreover, tests were carried out with a relatively small amount of silicon carbide. In this document, it is stated that the addition of zirconium, titanium dioxide and boric acid leads to only a slight improvement in the alkali resistance, while the additional of phosphorous acid (phosphate bond) resulted in an improvement in the resistance, although not a particularly great improvement. By contrast, the addition of silicon carbide led to a considerable improvement in the alkali resistance of the mixture. It is explained in this document that even adding 10% by weight of the silicon carbide leads to a considerable improvement. However, it is pointed out that the silicon carbide has to be added in the fine fraction or to the matrix of the mixture ((0.2 mm). Furthermore, it can be seen from Table 2 of this document that the phosphate bond, in combination with the addition of SiC, has an adverse effect on the alkali resistance.

U.S. Pat. No. 5,382,555 has disclosed a refractory shaped body which contains at least 50% by mass of Al₂O₃, in which metal carbide particles are to be present in an amount of from 3 to 25% by mass. The subject of this document is also the improvement in a shaped body with a high alumina content in terms of its resistance to molten slags; this brick is supposed to be substantially free of what are referred to as “black cores”. These “black cores” are the result of incomplete oxidation of the carbon in the shaped body or in the raw material. These “black cores” not only have esthetic drawbacks, but also have undesirable properties, in particular a reduced ability to withstand temperature changes and a tendency to flake in use. This is attributable to inhomogeneities in the microstructure. This document proposes producing a mixture in such a manner that the fired product has a refractory, clay-bonded basic batch with a high aluminum content, the intention being for the alumina content to be at least 50%; moreover, metallic carbide, in particular silicon carbide, is added in amounts of from 3% to 25%, although under no circumstances should more than 1.5% of metal carbide (−325 mesh (45 um) be added.

Therefore, the prior art and previous specialist knowledge state that SiC should not be used together with a phosphate bond and that, moreover, only an extremely small amount of fine SiC should be added to refractory shaped bodies, since otherwise “black cores” are formed, with negative consequences.

Despite the extensive literature cited above, which describes refractory shaped bodies containing SiC, shaped bodies of this type have no role whatsoever on the commercial market, since their properties are impossible to control. Although SiC-containing shaped bodies are marketed under the tradename Carsial, they have very SiC contents, in the range from 43 to 90%.

### BRIEF SUMMARY OF THE INVENTION

It is an object of the invention to provide a batch and a refractory shaped body produced therefrom which has an improved alkali resistance.

The object is achieved by a batch having the features set forth below; advantageous refinements are described below.

A further object is to provide a process for producing the batch and shaped body. This object is achieved by the further features set forth below: advantageous refinements are again given below.

### BRIEF DESCRIPTION OF THE DRAWINGS

The invention is explained by way of example with reference to a drawing, in which:

FIG. 1 illustrates the grain size distribution and the cumulative curve of the grain size distribution of the SiC used according to the invention.

FIG. 2 illustrates a shaped body according to the invention with cut-in crucible, in cross section after alkali attach from K₂O.

FIG. 3 illustrates a comparison shaped body without SiC after the alkali attack, which has been completely destroyed by alkali attack.

FIGS. 4A through 4F illustrate sintering results from an experiment concerning the production of refractory shaped bodies of the prior art as compared to the production of refractory shaped bodies of the composition of the present invention.

FIGS. 5A through 5D illustrate sintering results from an experiment concerning the microstructure (black core) of the refractory shaped body of the prior art as compared to the microstructure (black core) of the refractory shaped body of the present composition.

FIGS. 6A through 6D illustrate alkali resistance of several compositions of the prior art as compared to the composition of the present invention.

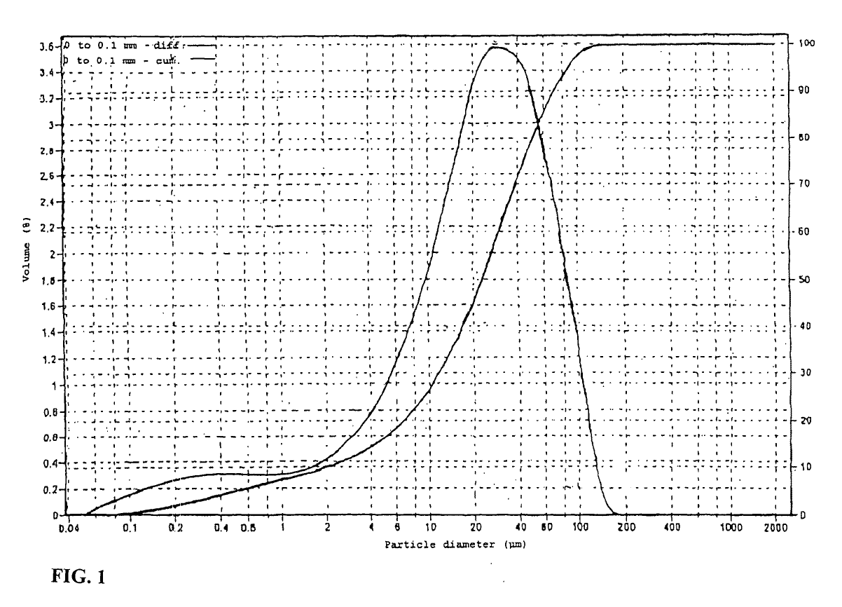

### DETAILED DESCRIPTION OF THE INVENTION

According to the invention, it has been discovered that, surprisingly, with a batch or shaped body made from this batch which contains 40% to 60% of Al₂O₃ and 3% to 15% of finely particulate SiC, the alkali resistance can be dramatically improved if a phosphate bond is used. This is even more surprising since it has hitherto been assumed that the addition of finely particulate SiC, on the one hand, and the phosphate bond, for example produced by phosphoric acid or monoaluminum phosphate, in combination with SiC, on the other hand, has major drawbacks for refractory shaped bodies or batches. According to the invention, contrary to previous specialist opinion, more than 1.5% of SiC of (0.045 mm is added approx. 75% of the SiC added lying in the range (0.045 mm. Overall, therefore, at least 2.3% of the SiC, based on the quantity of the total batch, is below 0.045 mm, given an addition of 3% based on the total mass. It should be noted that the batch excludes the presence of boron phosphate. Tests have established that even in the refractory shaped body produced according to the invention “black cores” may form. Surprisingly, however, it has been established that, in the shaped body according to the invention, these “black cores” do not cause any microstructural inhomogeneities which are such that this “black core” would cause weakening of the microstructure. The reason for this is not currently clear.

The invention is explained below with reference to an example. A high-alumina raw material containing 51% by weight of A 1203 with a maximum grain size of 4 mm and a grain size distribution corresponding to a typical Fuller curve is mixed with 5% of a refractory binding clay, the mixture including 5% of SiC with a grain size of from 0 to 0.9 mm. This mixture is mixed with the quantity of phosphoric acid which is usually required as binder component. After mixing to homogeneity, the mixture obtained in this way or the batch obtained in this way is pressed under a pressure of 90 Mpa. Then, the shaped bodies obtained are dried at temperatures of over 100° C., in particular 120° C., and, after subsequent drying, are fired at a sintering temperature of approx. 1260° C. For comparison purposes, a brick is produced in the same way, except that, instead of the silicon carbide, the high-alumina, refractory raw material or the refractory main component is added in the grain size which corresponds to the SiC. After firing, both shaped bodies have a homogeneous appearance and a homogeneous microstructure. There was no “black core” in the silicon carbide brick.

After firing, crucibles which have an edge length or 70 mm and an internal bore with a diameter or 40 mm were cut out of the two bricks in accordance with DIN 51069. To simulate alkali attack, these crucibles were filled with 70 g of potassium carbonate. The crucibles were then closed off with a cover made from the same material and were treated in a kiln for five hours at a temperature of 1100° C.

The result after firing is that the SiC-free shaped body has been greatly destroyed by the alkali attack (FIG. 3) and has large cracks. The microstructure reveals considerable infiltration.

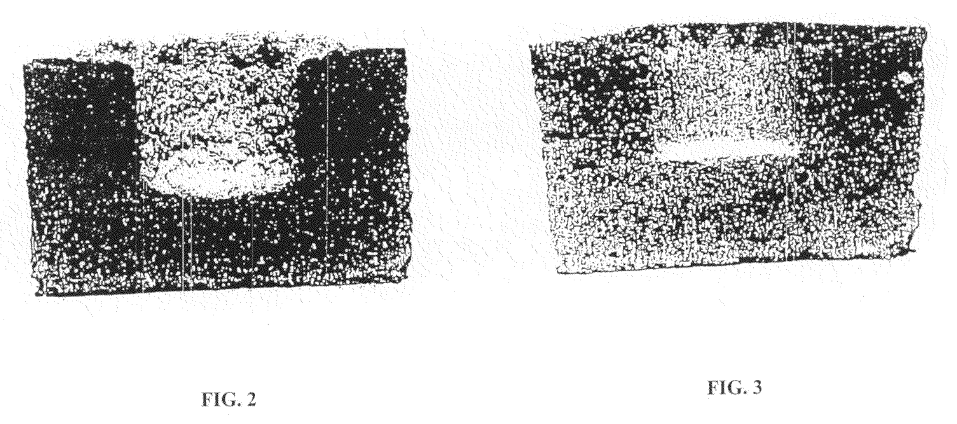

By contrast, the brick containing 5% of finely particulate SiC and a phosphate bond (FIG. 2) does not reveal any effect on the microstructure through the alkali attack. The shaped body is free of cracks. The alkali resistance of the shaped body according to the invention is, surprisingly, so high that potassium carbonate has boiled over out of the crucible, since it was unable to penetrate into the microstructure of the brick. The mechanism which leads to the dramatic increase in alkali resistance observed has not thus far been determined.

An advantage of the shaped body according to the invention is that is has an extremely high alkali resistance, so that it can be used wherever high concentrations of alkali occur in a high-temperature process. This includes, for example, preheating, safety and transition zones of rotary tubular kilns used in the mineral processing industry and also sintering zones in kilns of this type with moderated temperature stresses.

Example 1 describes an experiment concerning the production of refractory shaped bodies of the prior art as compared to the production of refractory shaped bodies of the composition of the present invention.

### Example 1

High-alumina shaped bodies containing approx. 60̂ by weight of Al₂O₃ were prepared to form refractory shaped bodies to investigate their burning behavior. #2 refractory body according the U.S. Pat. No. 5,338,711 consists of bauxite and fireclay which are adjusted to get an Al₂O₃—content in the fired body of 60% by weight by using a weight ratio of 1.1875. This body consists further of SiC-powder of 5% by weight, a boron phosphate addition of 4% by weight, and a phosphorous containing binder in an amount of 9.2% by weight.

#1 refractory body containing bauxite and fireclay which are adjusted to get an Al₂O₃—content in the fired body of 60% by weight by using a weight ratio of 1.1875. This body consists furthermore of SiC-powder of 5% by weight, and a phosphorous containing binder in an amount of 9.2% by weight.

These mixtures were pressed under a pressure of 80 MPa. Then, the shaped bodies were dried at a temperature of 150° C., and after drying the shaped bodies were fired at a sintering temperature of 1250° C.

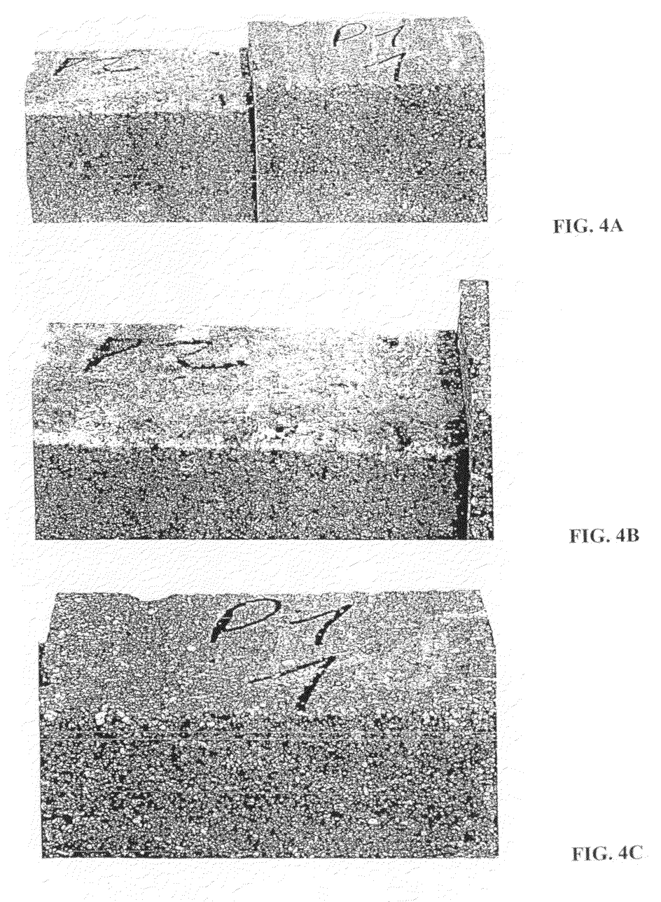

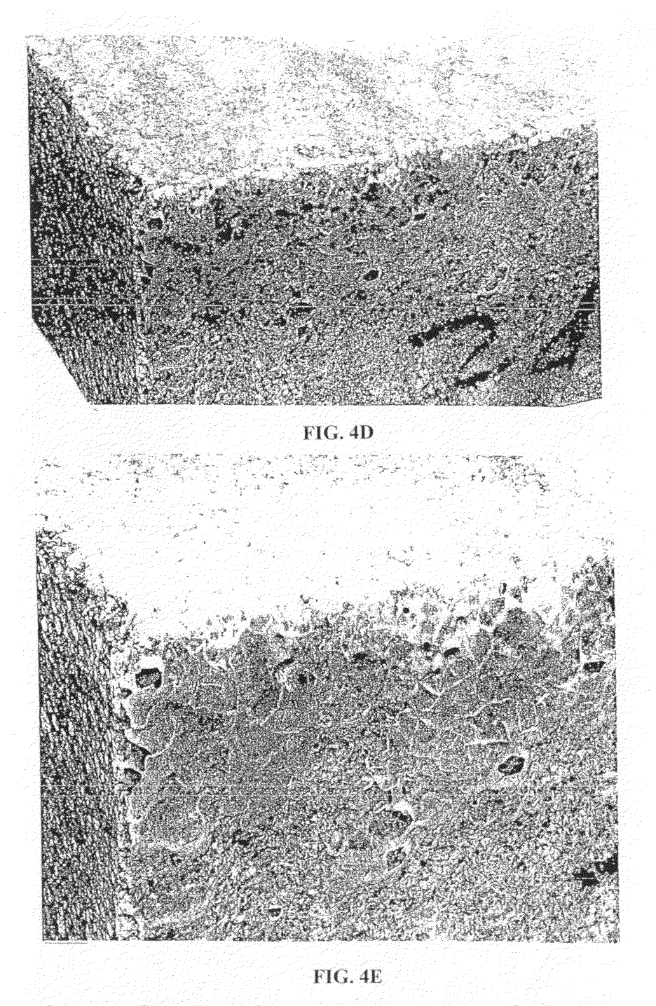

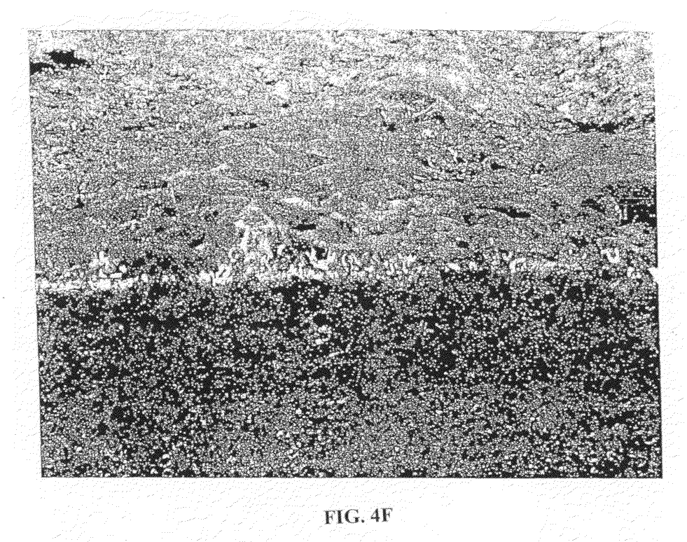

FIGS. 4A through 4F show the results after sintering, as follows:
FIG. 4A: comparison of refractory shaped body #2 (on the left) and refractory shaped body #1 (on the right) after firing at 1250° C.;
FIG. 4B: detailed view of refractory shaped body #2 after firing at 1250° C.; this material containing 60% Al₂O₃ forms severe glassy bubbles on the surface preventing any further investigations
FIG. 4C: detailed view of refractory shaped body #1 after firing at 1250° C.; this material containing 60% Al₂O₃ shows the typical appearance of a shaped refractory product after firing.

It is clearly shown that only the composition of the present invention (FIG. 4C) can be used as a refractory material due to its acceptable appearance. In contrast, the composition described in U.S. Pat. No. 5,338,711 (FIG. 4B) has lost its shape by forming a bubble-like structure, thus preventing the use as a refractory material. This becomes very clear in FIG. 4D, FIG. 4E, and FIG. 4F, where the bubbles are shown in a detailed view.

The cause of the behavior of the material described in U.S. Pat. No. 5,338,711 is not clear, but it is rather obvious that at least an amorphous boron phosphate silicate glass forms with the investigated composition, which becomes liquid and forms bubbles under the influence of temperature. This can be effectively prevented by the composition of the present invention, where a stable composition after firing is achieved, which can be used for refractory purposes according to the present invention.

Example 2 describes an experiment concerning the microstructure (black core) of the refractory shaped body of the prior art as compared to the microstructure (black core) of the refractory shaped body of the present composition.

### Example 2

High-alumina raw materials containing 51% by weight of Al₂O₃ or 71% by weight of Al₂O₃ were used to form refractory shaped bodies with different compositions. The maximum grain size was 4 mm. The grain size distribution corresponds to a typical fuller curve. These high alumina raw materials were mixed with 5% of a refractory bonding clay. The mixture also included 5% of SiC with the grain size from 0 to 0.9 mm. There were two refractory batches produced with a high-alumina raw material containing 51% by weight of Al₂O₃ and two refractory batches with 71% by weight of Al₂O₃. These four mixtures were mixed with a binder component, whereby the two refractory batches with 71% by weight of Al₂O₃ either contained 1.6% phosphoric acid and 1.2% water of 4% lignin sulfonate. The same components were mixed to the two refractory batches with 71% by weight of Al₂O₃. These four mixtures were pressed under a pressure of 90 MPa. Then, the shaped bodies were dried at a temperature of over 100° C., and after subsequent drying the shaped bodies were fired at a sintering temperature of 1260° C.

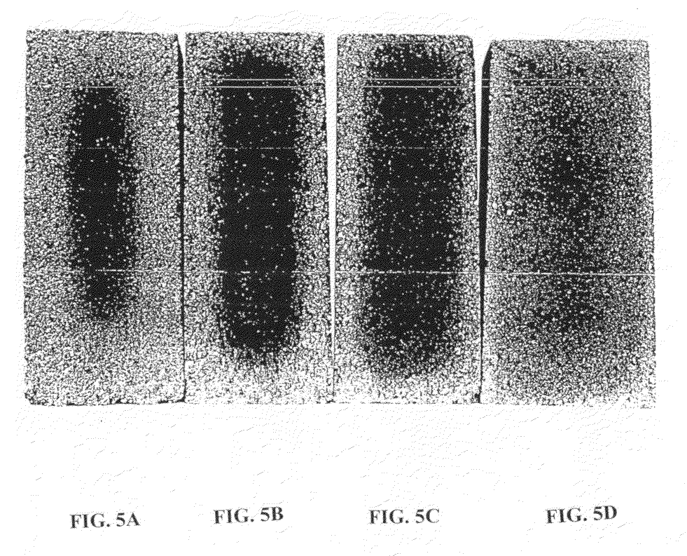

FIGS. 5a to 5d show the results after sintering, as follows:
FIG. 5A: raw material with 51% Al₂O₃ and lignin sulfonate;
FIG. 5B: raw material with 71% Al₂O₃ and lignin sulfonate;
FIG. 5C: raw material with 71% Al₂O₃ and phosphoric acid; and
FIG. 5D: raw material with 51% Al₂O₃ and phosphoric acid.

As shown in FIG. 5D, the composition of the present invention has superior microstructure than the compositions illustrated in FIGS. 5A, 5B and 5C.

Example 3 illustrates an experiment concerning alkali resistance of the compositions described in Example 2.

### Example 3

Crucibles were cut out of the four shaped bodies of Example 2 with an edge length of 70 mm and an internal bow with a diameter of 40 mm. To simulate alkali attack, these crucibles were filled with 70 g of potassium carbonate. The crucibles were then closed off with a cover made from the same material and were treated in a kiln for five hours at a temperature of 1100° C.

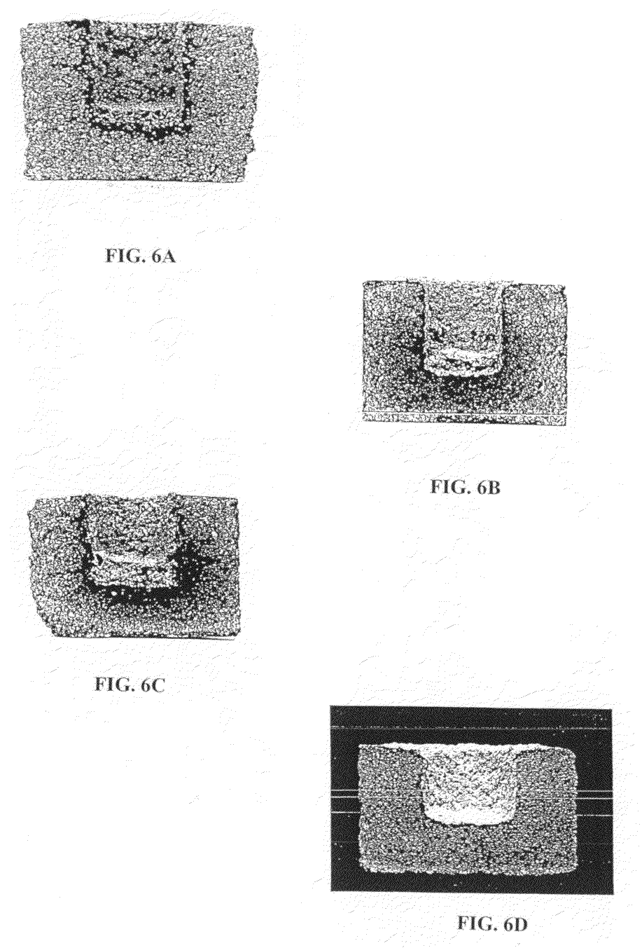

The results are shown in FIGS. 6A, 6B, 6C and 6D. The result after firing is that the microstructures of the comparative examples shown in FIGS. 6A, 6B and 6C reveal infiltration. The shaped bodies were considerably destroyed by the alkali attack.

By contrast, the brick of the present invention shown in FIG. 6D does not reveal any effect on the microstructure by the alkali attack. The shaped body is free of cracks. The alkali resistance of the shaped body according to the invention is, surprisingly, so high that potassium carbonate has boiled over out of the crucible, since it was unable to penetrate into the microstructure of the brick. Accordingly, the composition of the present invention yields a dramatic and unexpected increase in alkali resistance.

The present invention has been described with particular reference to certain preferred embodiments. It should be understood that the foregoing description and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

We claim:

1. A Batch consisting essentially of:
(a) a refractory metal oxide main component containing Al₂O₃; the refractory metal oxide main component containing 40 to 60% by weight of Al₂O₃;
(b) a phosphate bond, in particular, the phosphate bond being produced by at least one of a phosphoric acid and a monoaluminum phosphate;
(c) finely particulate SiC having a grain size of <0.2 mm, the batch containing 3 to 15% by weight of the finely particulate SiC; and
(d) the grain size distribution of the SiC being selected so that more than 2.0% of the SiC, based on a total quantity of the batch, is <0.045 mm, whereby said batch excludes the presence of boron phosphate.

2. The Batch as claimed in claim 1, wherein the batch contains 80 to 97% by weight of the refractory metal oxide main component.

3. The Batch as claimed in claim 1, wherein the batch has a SiC content of between 3 and 8% by weight.

4. The Batch as claimed in claim 1, wherein the SiC is a fused silicon carbide.

5. The Batch as claimed in claim 1, wherein the SiC is a regenerated silicon carbide product.

6. The Batch as claimed in claim 1, wherein the refractory, Al₂O₃— containing metal oxide main component contains up to 15% of refractory clay.

7. The Batch as claimed in claim 1, wherein a refractory shaped body is fabricated from the batch.

8. The Batch as claimed in claim 1, wherein the refractory, Al₂O₃-containing metal oxide main component includes natural raw materials selected from a sillimanite group, a refractory clay, and synthetic raw materials.

9. The Batch as claimed in claim 1, wherein the refractory, Al₂O₃-containing metal oxide main component includes natural raw materials selected from a sillimanite group.

10. The Batch as claimed in claim 1, wherein the refractory, Al₂O₃-containing metal oxide main component includes natural raw materials selected from a bauxite.

11. The Batch as claimed in claim 1, wherein the refractory, Al₂O₃-containing metal oxide main component includes natural raw materials selected from a refractory clay.

12. The Batch, as claimed in claim 1, wherein the refractory, Al₂O₃-containing metal oxide main component includes at least one of natural raw materials and/or synthetic raw materials.

13. The Batch as claimed in claim 12, wherein the synthetic raw materials include at least one of a sintered mullite, a calcined alumina, a sintered conrundum and a fused corundum.

14. A process for producing a batch, comprising the steps of:
(a) mixing a refractory, Al₂O₃-containing metal oxide main component containing 40 to 60% by weight of Al₂O₃ with a finely particulate SiC having a grain size of <0.2 mm; and
(b) adding at least one of a phosphoric acid and a monoaluminium phosphate as a binder component to form a mixture;
(c) the SiC being added to have a fineness and quantity so that, based on a total of the batch, more than 2.0% by mass of the SiC is <0.045 mm, whereby said batch excludes the presence of boron phosphate.

15. The process as claimed in claim 14, wherein 80 to 97% by weight of the refractory, Al₂O₃-containing metal oxide main component is admixed.

16. The process as claimed in claim 14, wherein between 3 and 8% by weight of the SiC is admixed.

17. The process as claimed in claim 14, wherein up to 15% of the refractory, Al₂O₃-containing metal oxide main component is replaced by refractory clay.

18. The process as claimed in claim 14, wherein a fused silicon carbide is used as the SiC.

19. The process as claimed in claim 14, wherein a regenerated silicon carbide product is used as the SiC.

20. The process as claimed in claim 14, wherein the refractory, Al₂O₃-containing metal oxide main component is used with a maximum grain size of 4 mm and a grain size distribution which corresponds to that of a typical Fuller curve.

21. The process as claimed in claim 14, wherein the batch is pressed into shaped bodies using a pressure of from 60 to 110 MPa.

22. The process as claimed in claim 21, wherein the shaped bodies are dried at temperatures of over 100° C.

23. The process as claimed in claim 22, wherein the shaped bodies, after drying, are fired at a sintering temperature of approximately 1100 to 1400° C.

24. The process as claimed in claim 14, wherein at least one of natural raw materials and synthetic raw materials are used as the refractory, Al₂O₃-containing metal oxide main component.

25. The process as claimed in claim 24, wherein the natural raw materials include raw materials selected from at least one of a sillimanite group, a bauxite, and a refractory clay.

26. The process as claimed in claim 24, wherein the synthetic raw materials include at least one of a sintered mullite, a fused mullite, a calcined alumina, a sintered corundum and a fused corundum.
